(19) United States
(12) Patent Application Publication
(10) Pub. No.: US 2018/0326677 A1
(43) Pub. Date: Nov. 15, 2018

(54) METHOD AND DEVICE FOR MOULDING A COMPOSITE COMPONENT, COMPOSITE COMPONENT AND CRAFT

(71) Applicant: GECO INGENIERIE, Laudun L'ardoise (FR)

(72) Inventor: Frederic ROURE, Laudun L'ardoise (FR)

(21) Appl. No.: 15/777,218

(22) PCT Filed: Nov. 10, 2016
(86) PCT No.: PCT/FR2016/052927

§ 371 Date: May 18, 2018

(30) Foreign Application Priority Data
Nov. 20, 2015 (FR) 1561205

(51) Int. Cl. B29C 70/34; B29C 70/08; B63B 5/24

(52) U.S. Cl. CPC B29C 70/345; B29K 2311/10; B63B 5/24; B29C 70/08

(57) ABSTRACT

The method (10) of molding a composite component comprises:
a step (105) of positioning a layer of geotextile on a mold so that a lower surface of the layer of geotextile is positioned against the mold,
a first step (110) of coating an upper surface of the layer of geotextile positioned during the positioning step with a biodegradable resin,
a step (115) of bonding a layer of fibers, having a higher rigidity than the layer of geotextile, against the coated layer of geotextile, and
a second step (120) of coating an upper surface of the layer of fibers with a biodegradable resin.

### TECHNICAL FIELD OF THE INVENTION

The present invention envisages a method for molding a composite component, a device for molding a composite component, a composite component and a watercraft. It applies, in particular, to the manufacture of small leisure watercraft.

### STATE OF THE ART

In the field of manufacturing composite components, and especially of small leisure watercraft wherein one side is formed of an NCE composite component, a manufacturing technique consists of molding the composite component by superimposing layers on a mold.

There are two types of superimposed layers:
a mat made of fibers, generally consisting of glass fibers not arranged in any order; and
a fabric made of fibers, generally consisting of glass or polyester fibers, wherein the fibers are arranged and woven in a regular way along two axes, known as “roving”.

A resin is applied between these layers such that the layers are bonded to each other.

The composite components produced in this way have the advantages of not requiring skilled labor and of having a low manufacturing cost.

However, these composite components have the disadvantage of not being biodegradable and being difficult to recycle, and, due to their low cost, in the case of small leisure and pleasure watercraft, are frequently discarded by users. As a consequence, such damaged watercraft and composite components pollute nature sites, watercourses and shores.

### SUBJECT OF THE INVENTION

The present invention aims to remedy all or part of these drawbacks.

To this end, according to a first aspect, the present invention envisages a method for molding a composite component, which comprises:
a step of positioning a layer of geotextile on a mold so that a lower surface of the layer of geotextile is positioned against the mold;
a first step of coating an upper surface of the layer of geotextile positioned during the positioning step with a biodegradable resin;
a step of bonding a layer of fibers, whose rigidity is higher than that of the geotextile layer, against the coated geotextile layer; and
a second step of coating an upper surface of the layer of fibers with a so biodegradable resin.

Thanks to these provisions, the geotextile can be biologically degraded if the composite component is discarded by a user. In this way, the ecological footprint of the composite component is reduced while the advantages of this manufacturing method are retained.

In some embodiments, the method that is the subject of the present invention comprises, after the positioning step and/or the bonding step, a step of stamping the upper surface of the layer farthest from the mold.

These embodiments make it possible to remove air bubbles contained in the space between the mold and the geotextile or between the layer of fibers and the geotextile.

In some embodiments, the method that is the subject of the present invention comprises a step of positioning ribs made of a natural material matching the shape of the mold, these ribs being covered by the geotextile layer during the step of positioning this geotextile.

These embodiments make it possible to strengthen the molded composite component.

In some embodiments, the method that is the subject of the present invention comprises, after the second coating step, an additional step of positioning a geotextile layer so that a lower surface of the geotextile layer is positioned against the layer of fibers.

These embodiments make it possible to produce a multi-layered thickness of the molded composite component.

According to a second aspect, the present invention envisages a device for molding a composite component, which comprises:
a geotextile layer having a lower surface to be positioned against a mold;
a biodegradable resin for coating an upper surface of the geotextile layer;
a layer of fibers, whose rigidity is higher than that of the geotextile layer, to be positioned against the coated geotextile layer;
a biodegradable resin for coating an upper surface of the layer of fibers.

As the particular aims, advantages and features of the device that is the subject of the present invention are similar to those of the method that is the subject of the present invention, they are not repeated here.

In some embodiments, the geotextile layer comprises fragments of technical synthetic fibers.

These embodiments make it possible to recycle waste produced by the petroleum-sourced products industry.

In some embodiments, the fragments of technical synthetic fibers are carbon fiber waste and/or by-products.

These embodiments make it possible to recycle waste produced by the petroleum-sourced products industry.

In some embodiments, the geotextile utilized is a geotextile made of non-woven natural fibers.

In some embodiments, the device that is the subject of the present invention comprises at least one rib made of natural material to be positioned against the mold.

In some embodiments, the layer of fibers is a layer made of biodegradable natural fibers.

According to a third aspect, the present invention envisages a composite component, which comprises, successively, in its thickness:
a layer of geotextile;
a biodegradable resin coating on the geotextile layer;
a layer of fibers whose rigidity is higher than that of the geotextile layer;
a biodegradable resin coating on the layer of fibers.

As the particular aims, advantages and features of the composite component that is the subject of the present invention are similar to those of the method that is the subject of the present invention, they are not repeated here.

In some embodiments, the composite component that is the subject of the present invention also comprises ribs.

According to a fourth aspect, the present invention envisages a watercraft, which comprises a side formed from at least one composite component that is the subject of the present invention.

As the particular aims, advantages and features of the method that is the subject of the present invention are similar to those of the device that is the subject of the present invention, they are not repeated here.

### BRIEF DESCRIPTION OF THE FIGURES

Other advantages, aims and particular features of the invention will become apparent from the non-limiting description that follows of at least one particular embodiment of the method, device, composite component and watercraft that are the subjects of the present invention, with reference to drawings included in an appendix, wherein:

FIG. 1 represents, schematically and in the form of a logical diagram, a particular series of steps of the method that is the subject of the present invention;

FIG. 2 represents, schematically, a particular embodiment of the device that is the subject of the present invention;

FIG. 3 represents, schematically and in cross-section, a particular embodiment of the watercraft that is the subject of the present invention; and

FIG. 4 represents, schematically and in cross-section, a particular embodiment of the composite component that is the subject of the present invention.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way. In addition, each parameter of an example of realization can be utilized independently from the other parameters of said example of realization.

It is now noted that the figures are not to scale.

It is now noted that the fibers forming the layers of fibers described below are preferably more than seven centimeters long.

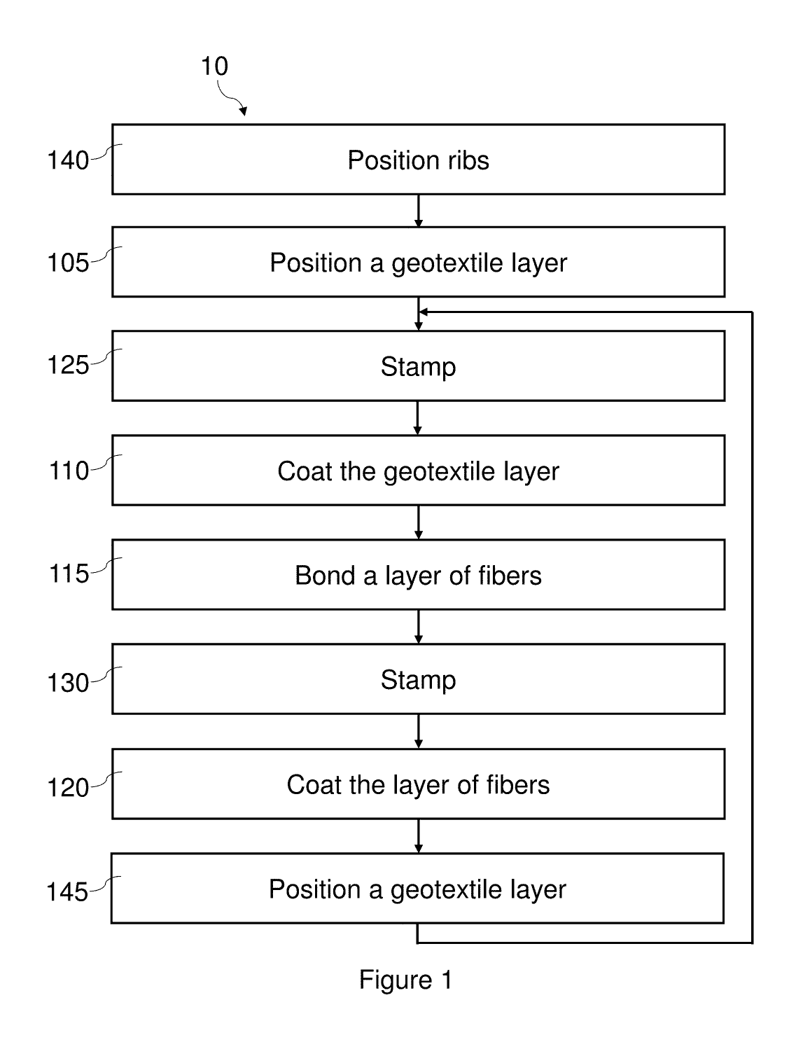

FIG. 1 shows, schematically and in the form of a logical diagram, a particular series of steps of the method 10 that is the subject of the present invention. This method 10 of molding a composite component comprises:
a step 105 of positioning a geotextile layer on a mold so that a lower surface of the geotextile layer is positioned against the mold;
a first step 110 of coating an upper surface of the geotextile layer positioned during the positioning step 105 with a biodegradable resin;
a step 115 of bonding a layer of fibers, whose rigidity is higher than that of the geotextile layer, against the coated geotextile layer; and
a second step 120 of coating an upper surface of the layer of fibers with a biodegradable resin.

If the molded composite component must have a curved shape, such as a side of a watercraft for example, a mold is positioned on a rigid surface prior to carrying out the positioning step 105. This mold is concave or convex:
if the mold is concave, the thickness of the composite component or watercraft is formed from the outside inwards; and
if the mold is convex, the thickness of the composite component or watercraft is formed from the inside outwards.

Preferably, a biodegradable resin is positioned between the mold and the geotextile layer positioned during the positioning step 105.

During the step 105 of positioning a geotextile layer, a user or an automated device deposits the geotextile layer against the mold such that this geotextile layer adopts the shape of the mold.

This geotextile layer is coated with a biodegradable resin during the coating step 110. This biodegradable resin is, for example:
resin “Bioresin 2 T MD 622-T” or “Bioresin 2 T MD 625-T” from Bioresin; or
   resin “EcoComp UV-L” (registered trademark) from Sustainable Composites Ltd.

The resin used can be thermoset, cured by ultraviolet radiation, or cured by contact with the ambient air.

During the bonding step 115, a layer of fibers is positioned against the geotextile layer so as to adopt its shape, ie to adopt the shape of the mold. The resin coated on the geotextile enables the bonding of the layer of fibers.

The material forming the fiber layer is chosen to have greater rigidity than the material forming the geotextile layer. Rigidity means resistance to twisting, tearing and piercing.

During the coating step 120, the fiber layer is coated with a resin similar to the resin utilized during the coating step 110.

In some variants, a layer of fibers is positioned against the mold during the positioning step 105, and a geotextile layer is bonded to this fiber layer during the bonding step 115.

In some embodiments, such as that shown in FIG. 1, the method 10 comprises, after the positioning step 105 and/or the bonding step 115, a step, 125 or 130, of stamping the upper surface of the layer farthest from the mold.

During each stamping step, 125 or 130, a rigid mass is pressed repeatedly against the upper surface of the layer farthest from the mold so as to cause the removal of air bubbles contained between this layer and a layer or the mold below.

Preferably, the method 10 comprises a stamping step 125 after the positioning step 105, and a stamping step 130 after the bonding step 115.

In some embodiments, such as that shown in FIG. 1, the method 10 comprises a step 140 of positioning ribs made of a natural material matching the shape of the mold, these ribs being covered by the geotextile layer during the step 105 of positioning this geotextile.

The ribs are, for example, rods made of wood or metal positioned against the mold or between two successive layers. These rods are, for example, in the form of strips whose rigidity is higher than the rigidity of the layer of fibers. These strips are deformed so as to adopt the shape of the mold. In some variants, the strips are positioned so as to form a grid.

In some embodiments, such as that shown in FIG. 1, the method 10 comprises, after the second coating step 120, an additional step 145 of positioning a geotextile layer so that a lower surface of the geotextile layer is positioned against the layer of fibers.

This additional positioning step 145 is performed in a similar way to the positioning step 105, except that the geotextile layer is positioned against the layer of fibers instead of against the mold.

In some variants, the steps of coating 110, bonding 115, coating 120 and positioning 145 are performed successively in an iterative way.

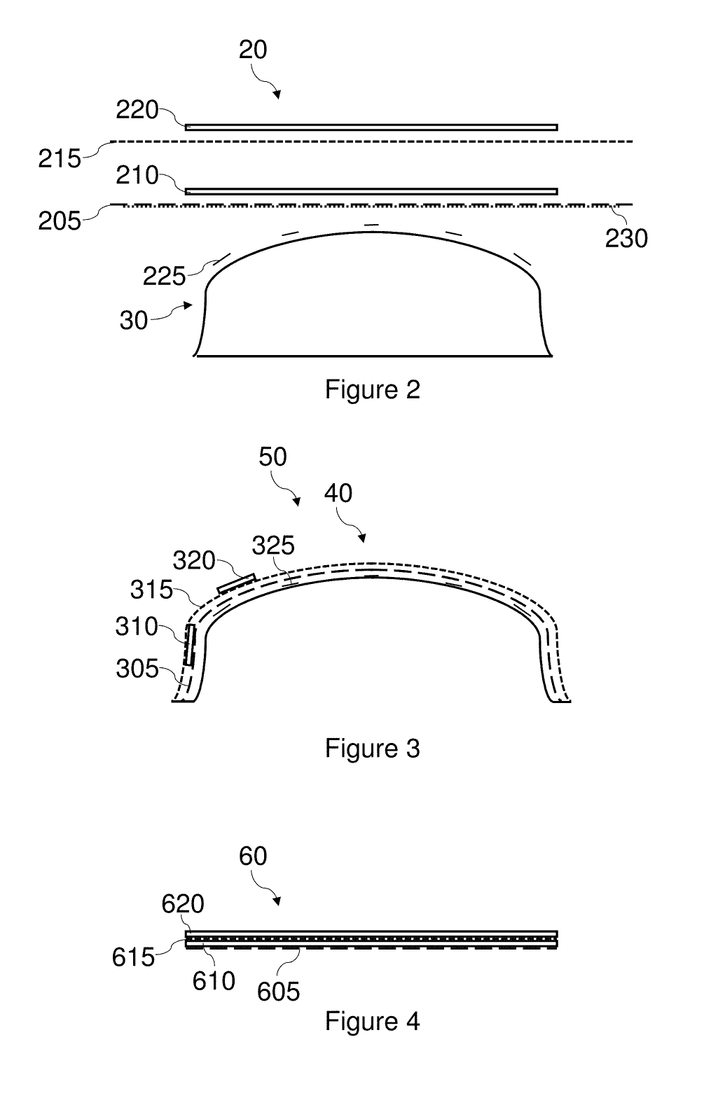

FIG. 2 shows, schematically and in cross-section, a particular embodiment of the device 20 that is the subject of the present invention. This device 20 for molding a composite component comprises:
a geotextile layer 205 having a lower surface to be positioned against a mold 30;
a biodegradable resin 210 for coating an upper surface of the geotextile layer;
a layer 215 of fibers, whose rigidity is higher than that of the geotextile layer, to be positioned against the coated geotextile layer;
a biodegradable resin 220 for coating an upper surface of the layer of fibers.

The geotextile layer 205 consists of a biodegradable geotextile, such as jute fabric for example.

Preferably, the geotextile utilized is a geotextile made of non-woven natural fibers. This non-woven geotextile comprises:
crushed vegetation stems having a diameter of more than five millimeters,
vegetation stem fragments and
vegetable fibers partially attached to said crushed stems, the stems and stem fragments being interwoven by means of mechanical links produced by spraying water.

This geotextile is produced, for example, by utilizing a method comprising:
a step of arranging vegetation into a mat of crushed vegetation with a diameter greater than five millimeters, vegetation stem fragments, and raw vegetable fibers partially attached to the crushed stems; and
a step of spraying water onto said mat to form mechanical links between the crushed vegetation stems, the vegetation stem fragments, and the vegetable fibers of said mat.

This method comprises, for example:
a step of introducing vegetation in the form of large-size vegetation, such as stems up to 2.5 meters in length, for example;
a step of partially reducing the vegetation into stems to form stem elements preferably over twenty centimeters long, and preferably over fifty centimeters long;
a step of crushing vegetation to form a mat of crushed vegetation with a diameter greater than five millimeters, vegetation stem fragments, and raw vegetable fibers partially attached to said crushed stems;
a step of pointing stems and/or fibers in different directions;
a step of making the thickness of the fiber mat uniform;
a step of incorporating ropes or cables into the fibers, parallel to the length of the fiber mat;
a step of creating mechanical links between the fibers of the mat, in the depth of the mat, by spraying water under pressure onto the vegetable fibers or, in a variant, with a multi-needle quilting machine.

The vegetation material used for implementing this method is, for example, a set of hemp fibers. Using vegetation material makes it possible, in particular, to make the geotextile biodegradable. The fiber layer is, for example, a layer of woven or non-woven biodegradable natural fibers. These natural fibers are, for example, hemp.

In some embodiments, the geotextile layer 205 comprises fragments 230 of technical synthetic fibers.

“Technical fiber” means a fiber that enables the manufacture of a textile, this fiber having characteristics allowing it to be included in the composition of textiles used in hostile environments. Such fibers are sometimes called “technical textiles”.

In some embodiments, the fragments 230 of technical synthetic fibers are carbon fiber waste and/or by-products.

These technical fiber fragments are, for example, waste obtained during the creation of petroleum-sourced products. This carbon fiber waste is obtained, for example, in the aeronautics or automobile industries and is difficult to recycle.

In some preferred embodiments, as shown in FIG. 2, the device 10 comprises at least one rib 225 made of natural material to be positioned against the mold 30. Each rib 225 is, for example, a strip or a slat made of wood.

FIG. 3 shows, schematically and in cross-section, a particular embodiment of the watercraft 40 that is the subject of the present invention. This watercraft 40 comprises a side formed from at least one composite component comprising, successively, in its thickness:
a geotextile layer 305;
a biodegradable resin 310 coating on the geotextile layer;
a layer 315 of fibers, whose rigidity is higher than that of the geotextile layer; and
a biodegradable resin 320 coating on the layer of fibers.

In some preferred embodiments, as shown in FIG. 3, the watercraft 40 also comprises ribs 325.

FIG. 4 shows, schematically and in cross-section, a particular embodiment of the composite component 60 that is the subject of the present invention. This composite component, formed by molding, comprises, successively, in its thickness:
a geotextile layer 605;
a biodegradable resin 610 coating on the geotextile layer;
a layer 615 of fibers, whose rigidity is higher than that of the geotextile layer; and a biodegradable resin 620 coating on the layer of fibers.

The composite component 60 has, in FIG. 4, a flat shape, but it can be of any shape whatsoever, the negative of the mold on which the component 60 is molded.

1. Method of molding a composite component, comprising:
a step of positioning a geotextile layer on a mold so that a lower surface of the geotextile layer is positioned against the mold;
a first step of coating an upper surface of the geotextile layer positioned during the positioning step with a biodegradable resin;
a step of bonding a layer of fibers, whose rigidity is higher than that of the geotextile layer, against the coated geotextile layer; and
a second step of coating an upper surface of the layer of fibers with a biodegradable resin.

2. Method according to claim 1, which comprises, after the positioning step and/or the bonding step, a step of stamping the upper surface of the layer farthest from the mold.

3. Method according to claim 1, which comprises a step of positioning ribs made of a natural material matching the shape of the mold, these ribs being covered by the geotextile layer during the step of positioning this geotextile.

4. Device for molding a composite component, comprising:
a geotextile layer having a lower surface to be positioned against a mold;
a biodegradable resin for coating an upper surface of the geotextile layer;
a layer of fibers, whose rigidity is higher than that of the geotextile layer, to be positioned against the coated geotextile layer;
a biodegradable resin for coating an upper surface of the layer of fibers.

5. Device according to claim 4, wherein the geotextile utilized is a geotextile made of non-woven natural fibers.

6. Device according to claim 4, wherein the geotextile layer comprises fragments of technical synthetic fibers.

7. Device according to claim 6, wherein the fragments of technical synthetic fibers are carbon fiber waste and/or by-products.

8. Device according to claim 4, wherein the layer of fibers is a layer made of biodegradable natural fibers.

9. Composite component comprising, successively, in its thickness:
a geotextile layer;
a biodegradable resin coating on the geotextile layer;
a layer of fibers, whose rigidity is higher than that of the geotextile layer;
a biodegradable resin coating on the layer of fibers.

10. Watercraft, comprising a side formed from at least one composite component according to claim 9.
